(19) United States
(12) Patent Application Publication
(10) Pub. No.: US 2003/0078045 A1
(43) Pub. Date: Apr. 24, 2003

(54) Soft stream hand over

(76) Inventors: Anders Norstrom, Sodertalje (SE); Kay Johansson, Waxholm (SE); Thomas Kjell, Stockholm (SE); Kent Karlsson, Jarfalla (SE); Emil Petersson, Jarfalla (SE)

Correspondence Address: JENKENS & GILCHRIST, PC, 1445 ROSS AVENUE, SUITE 3200, DALLAS, TX, 75202, US

(21) Appl. No.: 10/263,486

(22) Filed: Oct. 2, 2002

Related U.S. Application Data
(60) Provisional application No. 60/326,876, filed on Oct. 2, 2001.
(60) Provisional application No. 60/326,858, filed on Oct. 2, 2001.

(51) Int. Cl. H04Q 7/20

(52) U.S. Cl. 455/436; 455/456; 455/440

(57) ABSTRACT

Method and apparatus for providing a substantially seamless hand over of a user receiving a data stream when the user moves from a first location served by a first server to a second location served by a second server. The data stream is provided at both the first and the second servers, and the data streams at the first and second servers are synchronized so that when the user moves from the first location to the second location, the user will start receiving the data stream at the second location at substantially a same point in the data stream at which the user stops receiving the data stream at the first location.

This application claims the benefit of copending U.S. Provisional Patent Application Serial No. 60/326,876 filed Oct. 2, 2001.

### BACKGROUND OF THE INVENTION

1. Field of the Invention

The present invention relates generally to the mobile telecommunications field; and, more particularly, to a method and apparatus for providing a soft stream hand over in a radio-based wireless telecommunications network

2. Description of the Prior Art

In a Radio Network having a distributed network, relay/cache servers are used at certain nodes in the Radio Network to provide a good Quality of Service (QoS) A similar approach is used on the Internet. A distributed network provides improved QoS because it helps avoid bottlenecks in the infrastructure of the Network.

FIG. 1 is a diagram that schematically illustrates the operation of a distributed network 10 for transmitting a data stream over the Internet. As shown in FIG. 1, a data stream from a master stream server 12 is transmitted to any or all of a plurality of clients, designated by computers 14, via the Internet, generally designated by reference number 16. The clients 14 may be at different locations, e.g., Stockholm, New York and London, and each client receives the stream via a relay/cache stream server 18. In general, each client will receive the data stream via the closest relay/cache stream server 18.

A similar distributed network is utilized in a Radio Network to transmit a data stream. FIG. 2 is a diagram that schematically illustrates the operation of a distributed network 20 for transmitting a data stream over a Radio Network. As shown in FIG. 2, a master relay 22 of a Mobile Switching Center (MSC) 24 sends out a data stream to a plurality of Radio Network Controllers (RNCs) 26 via relay servers 28 associated with each RNC. A single MSC can control a plurality of RNCs, for example, ten RNCs, and is connected to each RNC with, for example, a 4 Mbit fiber. Each RNC is, in turn, connected to a plurality of Base Stations 30 via, for example, a 34 Mbit fiber, and a terminal 32, such as a mobile phone, is connected to a base station with up to 384 Kbits.

A difference between the Internet and a wireless radio-based network is that with the Internet, a client is connected to a fixed point (e.g., to the closest relay/cache server) during a particular session; whereas, in a radio-based network, a client must be able to move freely between relay servers during a session without any interruption of service. Specifically, with the Internet, a user connects to his Internet Service Provider (ISP) through a modem or a fixed line; and then receives the data stream from the closest relay/cache server. The user will remain connected to the same access point throughout the entire data transfer session. If a user moves from one location to another, for example, from New York to London, he will simply connect to another ISP in London and again receive the stream from the closest relay/cache server. In other words, with the Internet, when a user moves between locations, he disconnects from the Internet at the old location and then reconnects at the new location.

In a wireless radio-based network, on the other hand, a user connects with his terminal to the nearest Base Station, and if the user moves, there must be a hand over from one Base Station to another. In particular, the user is served by the relay server connected to the nearest Base Station. If the relay server is located at the RNC, it will serve all the Base Stations connected to that RNC. In such an arrangement, if the user moves from one Base Station to another Base Station served by the same RNC during a session, the data stream will not be affected by the hand over since the relay server remains the same. However, if the user moves to a new Base Station that is not served by the same relay server (not served by the same RNC), difficulties can occur.

Conventionally, a Radio Network handles the movement of a user from one Base Station served by a relay server of a first RNC to another Base Station served by a relay server of a second RNC by continuing to serve the stream from the relay server of the first RNC until the session is finished. FIGS. 3A and 3B are diagrams that schematically illustrates this procedure. In FIG. 3A, a user 40 is connected to a Base Station 42 which is being served by a relay server 44 to receive a data stream sent out by master relay 46. As shown in FIG. 3B, when the user 40 moves from Base Station 42 served by relay server 44 to Base Station 48 served by relay server 50, the stream must go back through the network from relay server 44 to the master relay 46 to the relay server 50. Although such a “back-end” procedure handles the hand over without interruption of the data stream, the procedure is unsatisfactory because it generates congestion in the network due to bandwidth problems.

This back-end procedure can be avoided by stopping the data stream until the user has connected to the new BS. The user would then request the stream from the now nearest relay server. A problem with such an approach is that the data stream will start streaming from the beginning, not at the point where the interruption occurred. This is clearly not an acceptable solution from the point of view of the user.

There is, accordingly, a need for a technique for hand over of a user receiving a data stream when the user moves from a first location served by a first server to a second location served by a second server that can be performed in a substantially seamless manner and that does not require that the data stream be streamed back through the back-end of a network.

### SUMMARY OF THE INVENTION

The present invention provides a method and apparatus for providing a substantially seamless hand over of a user receiving a data stream when the user moves from a first location served by a first server to a second location served by a second server, and that does not require that the data stream be streamed back through the back-end of a network.

According to an exemplary embodiment of the present invention, a hand over of a user receiving a data stream when the user moves from a first location served by a first server to a second location served by a second server is accomplished by providing the data stream at both the first and second servers, and synchronizing the data streams at the first and second servers to provide a substantially seamless hand over when the user moves from the first location to the second location.

According to an exemplary embodiment of the invention, the hand over of the user when the user moves from the first location to the second location is controlled by an Application Program Interface (API). The API synchronizes the first and second servers so that they both play the exact time frame of the data stream (and, in fact, so that the data streams are synchronized down to the bit level). Accordingly, when the hand over is made, the user will “see” the data stream in a substantially seamless manner without any interruption. According to an exemplary embodiment of the invention, synchronization is accomplished by using a time stamp to calculate and synchronize between the data streams at the first and second servers.

In general, with the present invention, a technique is provided to achieve a substantially seamless hand over of a user when the user moves from a first location served by a first server to a second location served by a second server. The invention accomplishes the hand over without having to stream the data through the back-end of a network.

### BRIEF DESCRIPTION OF THE DRAWINGS

The foregoing and other advantages of the present invention will become apparent upon reading the following detailed description, when taken in conjunction with the following drawings, wherein:

FIG. 1 is a diagram that schematically illustrates the operation of a distributed network for transmitting a data stream over the Internet;

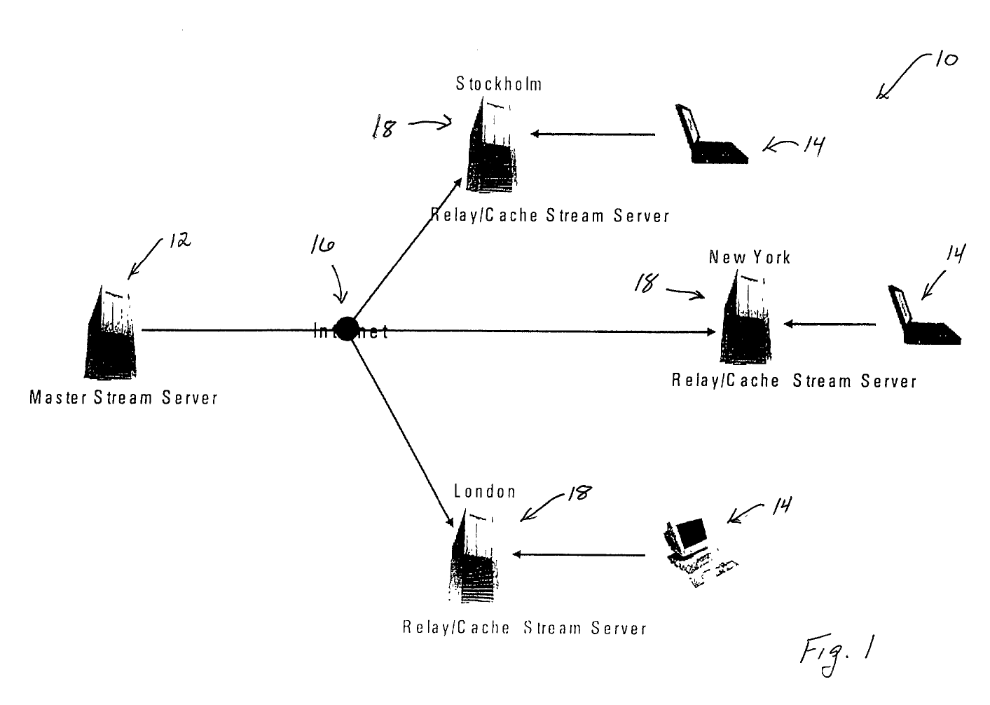

FIG. 2 is a diagram that schematically illustrates the operation of a distributed network for transmitting a data stream over a wireless radio-based network;

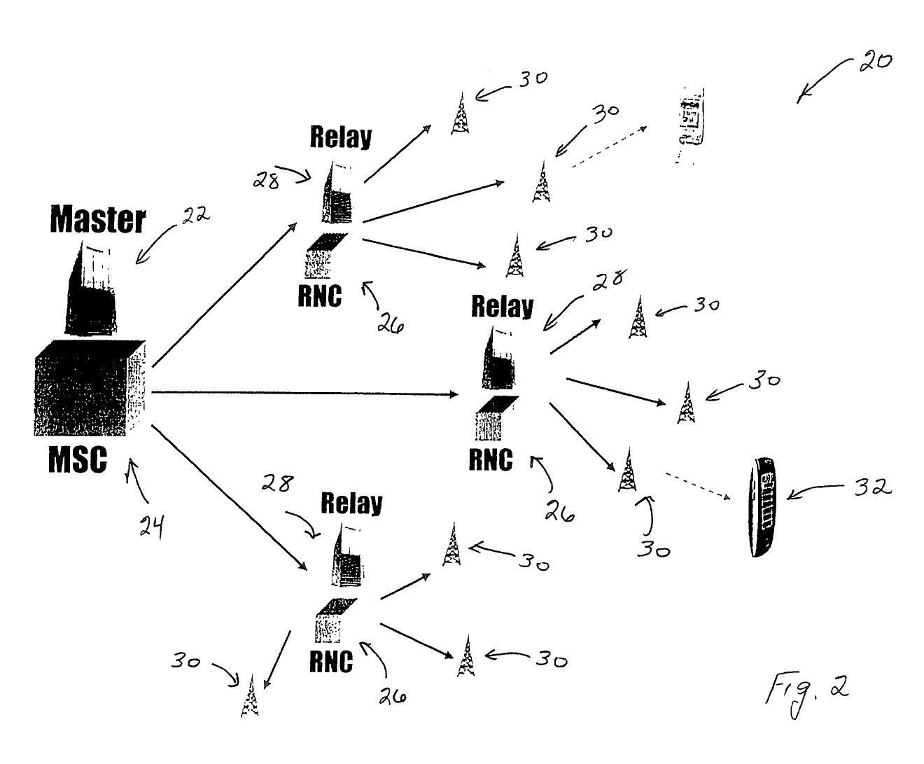

FIGS. 3A and 3B are diagrams that schematically illustrate a known procedure for hand over of a user from a first location served by a first relay server to a second location served by a second relay server in a wireless radio-based network,

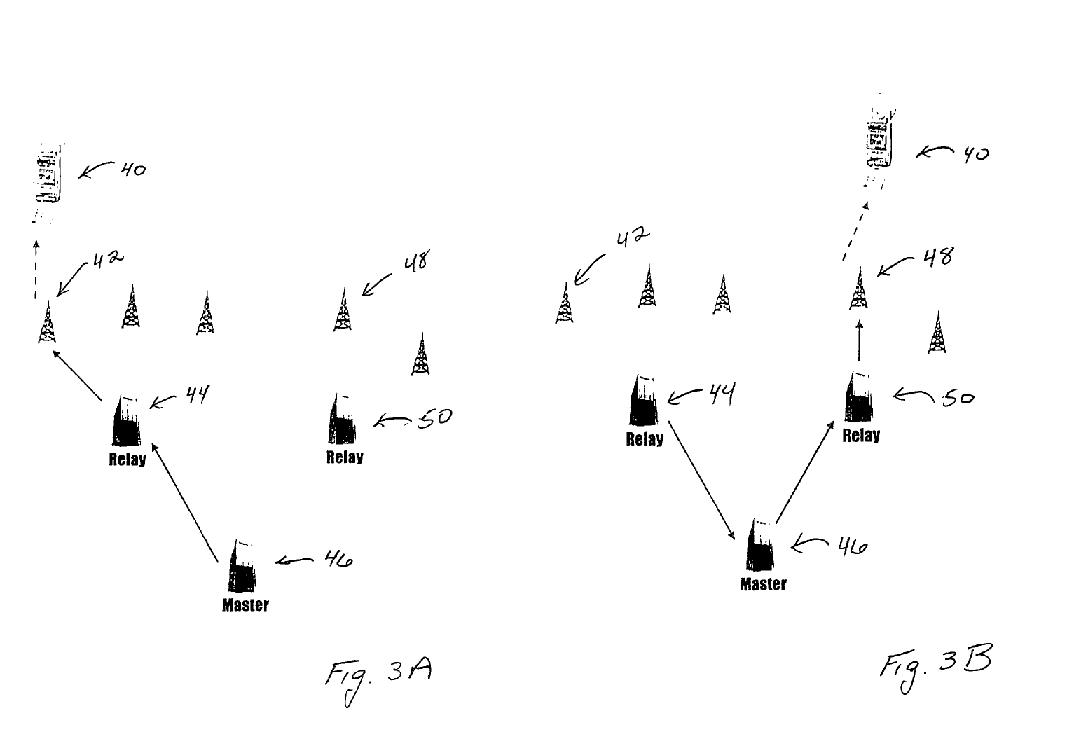

FIGS. 4A-4C are diagrams that schematically illustrate a procedure for a soft stream hand over of a user from a first location served by a first relay server to a second location served by a second relay server in a wireless radio-based network according to an exemplary embodiment of the present invention; and

FIG. 5 is a flow chart illustrating a method for a soft stream hand over of a user when the user moves from a first location served by a first relay server to a second location served by a second relay server in a wireless radio-based network according to another exemplary embodiment of the present invention.

### DETAILED DESCRIPTION OF EXEMPLARY EMBODIMENTS OF THE INVENTION

The present invention makes it possible for a user to receive an uninterrupted data stream when moving from a first location to a second location within a wireless network. In accordance with an exemplary embodiment of the present invention, the data stream is provided to both the relay server currently serving a user at the first location and to the relay server that will serve the user when the user moves to the second location in the wireless network. The data streams at the two relay servers are synchronized so that the user will begin receiving the stream at the second location at the same point at which he stops receiving the stream at the first location; and, in this way, the user will continue to receive the data stream in a substantially seamless manner when the hand over is made.

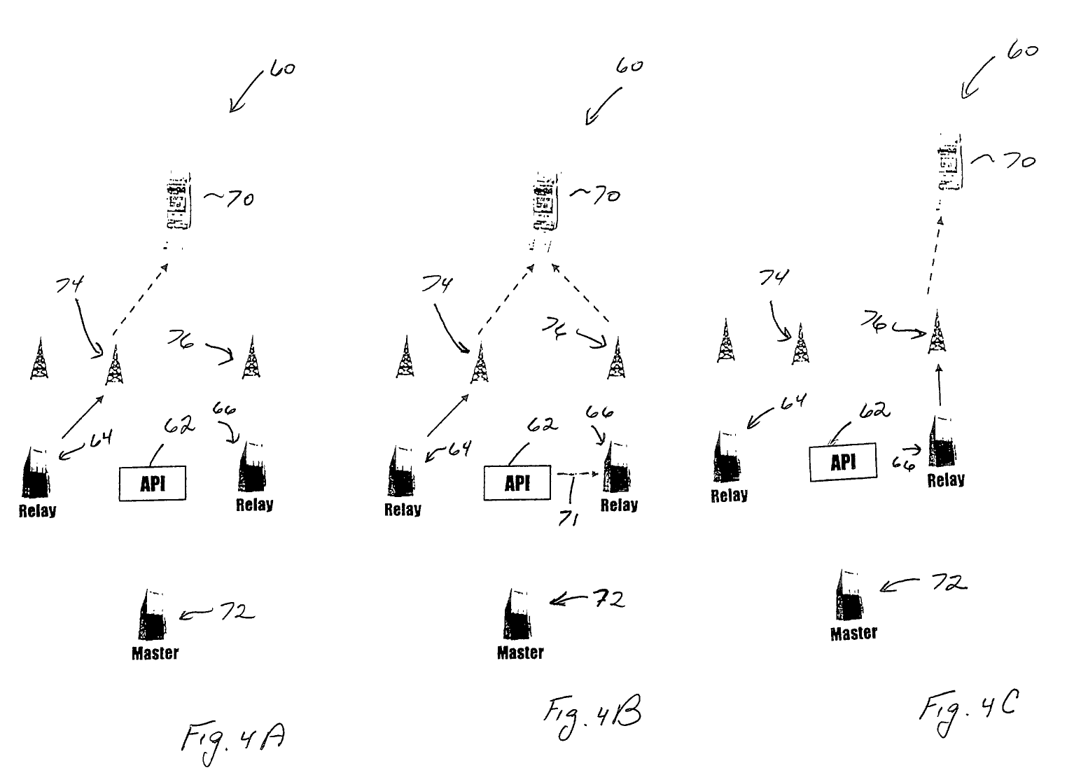

FIGS. 4A-4C are diagrams that schematically illustrates the manner in which a substantially seamless hand over of a user is accomplished when the user moves within a wireless network according to an exemplary embodiment of the invention. The wireless network is generally designated by reference number 60; and as shown in each of FIGS. 4A-4C, the network includes an Application Program Interface (API) 62 to handle and control a soft stream hand over of a user 70 when the user moves from a first location served by relay server 64 via Base Station 74 to a second location served by relay server 66 via Base Station 76.

Basically, the data stream that is being sent to the user from the first relay server is also provided at the second relay server. This can be accomplished in a variety of ways as is known to those skilled in the art, and, accordingly, is not described herein. When the user 70, who is at a first location being served by relay server 64 via Base Station 74 (FIG. 4A), moves to a second location being served by relay server 66 via Base Station 76, the API 62 starts the relay server 66 and synchronizes the playback as indicated by arrow 71 in FIG. 4B. The new relay server 66 then starts sending the data stream to the user 70 from the point where the old relay server 64 stops sending the data stream to the user (FIG. 4C). As a result, the user 70 will continue to receive the data stream in a seamless manner without any interruption

In order to accomplish a seamless hand over as described above, the hand over should be accomplished at the correct frame. This means, for example, that if user 70 has watched 34 seconds of a particular data stream from the first relay server 64, the hand over should occur exactly 34 seconds into the content that is being received from the second relay server 66. This synchronization is achieved in accordance with an exemplary embodiment of the present invention by utilizing a time stamp that is associated with every packet in the data stream. In particular, every bit within a video/audio stream has the same time stamp, and a codec utilizes this information to know which bits should be decoded to put together in a frame. Thus, when the user is going to be handed over to the new relay server 66, the API 62 synchronizes the two relay servers 64 and 66 down to the bit level so that they both play the exact same frame.

The present invention uses the time stamp as a base to calculate and synchronize between the streams. A problem that results when doing this is that the data stream has a random packet numbering. This problem is solved by a procedure developed in connection with synchronizing bit streams when switching between different bit rates in IP stream switching (see commonly assigned copending U.S. patent application Ser. No. 10/105,526 entitled METHOD AND APPARATUS FOR BROADCASTING STREAMING VIDEO, the disclosure of which is herein incorporated by reference). When switching between two streams, there are different bit numbering sequences so if the packets are not received in the correct order, they will be interpreted as being “wrong packets” and will be thrown away. With the technology described in the above-referenced co-pending application, the two streams are synchronized so that when switching, the packet numbering will be in the right order. This technique works for both live and on-demand data streams.

In order to operate properly, the API must know when to make the switch from one stream to the other. A 3G/GPRS Radio Network signals when a user moves from one Base Station to another Base Station, and the present invention utilizes this same information and feeds it into the API. In a W-LAN Network, the ID of the Base Station can be used to know “where” in the network it is so as to know which relay server is the closest. The soft stream handover API is an algorithm that synchronizes the IP-stream switching and which has an input to know when and where to switch.

With the present invention, accordingly, it becomes possible to effect a hand over of a user from one relay server to another relay server in a wireless network in a substantially seamless manner without having to send the data stream through the back-end of the Network (i.e., without having to send the stream back through the master server 72 illustrated in FIGS. 4A-4C).

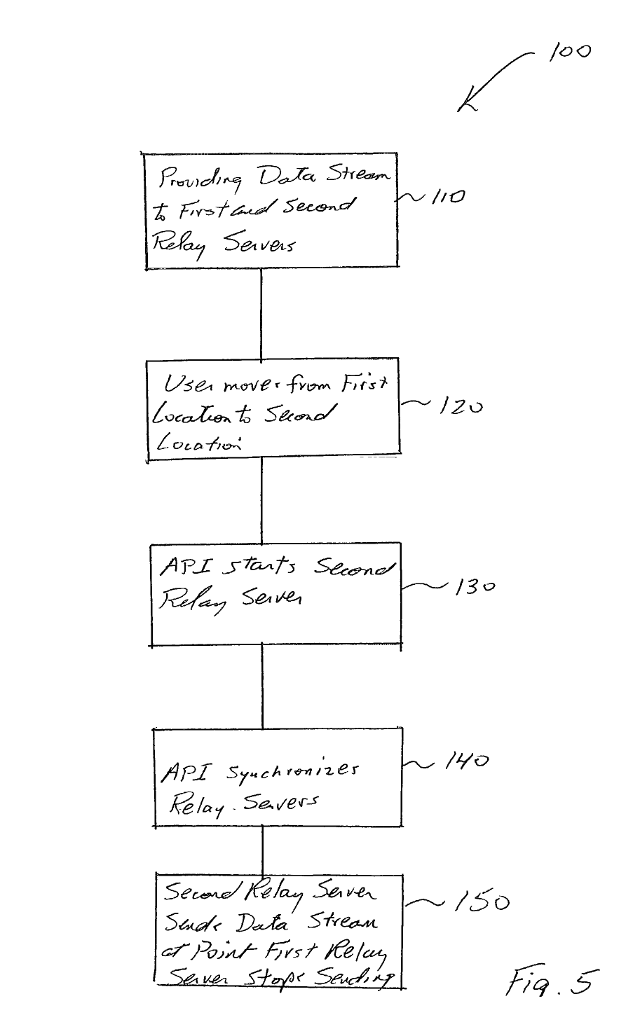

FIG. 5 is a flow chart that illustrates steps of a method for a soft stream handover of a user receiving a data stream from a first relay server to a second relay server in a wireless network according to an exemplary embodiment of the present invention. The method is generally designated by reference number 100, and begins by providing the data stream to both the first and the second relay servers (step 110). When the user moves from a first location at which the user is being served by the first relay server via a first Base Station, to a second location served by the second relay server via a second Base Station (step 120), the API starts the second relay server (step 130) and synchronizes the first and second relay servers (step 140) so that the second relay server starts sending the data stream to the user at substantially the exact point where the first relay server stops sending the data stream to the user (step 150). The user, accordingly, will experience a substantially seamless hand over without it being necessary to send the data stream through the back-end of the Network.

While what has been described herein constitutes exemplary embodiments of the present invention, it should be recognized that the invention can be varied in many ways without departing from the scope thereof For example, although in the exemplary embodiments described herein, a user is described as moving from a first location to a second location in a wireless radio-based network, the user can also move between networks. For example, a user could move from an enterprise having an internal network to an external wireless network. When the user starts moving, a handover is made so that the user is then being served from a server in the external wireless network. In other words, when the user is inside the premises of the enterprise, his mobile phone works like any PBX-connected phone. When the user moves outside the premises, he automatically begins receiving a data stream from a server in the external wireless network. Because the invention can be varied in many ways, it should be understood that the invention should be limited only insofar as is required by the scope of the following claims.

We claim:

1. A method for hand over of a user receiving a data stream when the user moves from a first location served by a first server to a second location served by a second server, the method comprising:
providing the data stream at both the first and second servers; and
synchronizing the data streams at the first and second servers to provide a substantially seamless hand over when the user moves from the first location to the second location.

2. The method according to claim 1, wherein the synchronizing step comprises synchronizing the data streams at the first and second servers at a bit level of the data streams.

3. The method according to claim 1, wherein said synchronizing step comprises synchronizing the data streams with a time stamp associated with every packet in the data streams.

4. The method according to claim 1, wherein said method further includes the step of switching from the data stream at the first server to the data stream at the second server when the user moves from the first location to the second location whereby the user will start receiving the data stream from the second server at substantially the same time that the user stops receiving the data stream from the first server.

5. The method according to claim 1, wherein the first and second servers are in a wireless telecommunications network.

6. The method according to claim 5, wherein said wireless network includes an Application Program Interface (API) for synchronizing the data streams at the first and second servers.

7. The method according to claim 6, wherein said API includes an input for indicating when to switch from the data stream at the first server to the data stream at the second server.

8. A wireless network, comprising:
a first server for serving a data stream to a user;
a second server for serving the data stream to the user; and
an Application Program Interface (API) for synchronizing the data streams at the first and second servers for providing a substantially seamless hand over when the user moves from a first location served by the first server to a second location served by the second server.

9. The apparatus according to claim 8, wherein the API synchronizes the data streams using a time stamp associated with every packet in the data streams

10. The apparatus according to claim 8, wherein the API includes an input for indicating when the user moves from the first location to the second location whereby the user will start receiving the data stream from the second server at substantially the same time that the user stops receiving the data stream from the first server.

11. The apparatus according to claim 8, wherein said data stream comprises an audio/visual data stream.
